(19) United States
(12) Patent Application Publication
(10) Pub. No.: US 2021/0010983 A1
(43) Pub. Date: Jan. 14, 2021

(54) MICROCHANNEL PHOTOIONIZATION DETECTOR

(71) Applicant: Nanova Environmental, Inc., Columbia, MO (US)

(72) Inventors: Haisheng ZHENG, Columbia, MO (US); Weicai WANG, Columbia, MO (US); Jun YIN, Columbia, MO (US)

(73) Assignee: Nanova Environmental, Inc., Columbia, MO (US)

(21) Appl. No.: 16/506,758

(22) Filed: Jul. 9, 2019

(51) Int. Cl. G01N 30/64; G01N 30/60; G01N 27/62

(52) U.S. Cl. CPC G01N 30/64; G01N 2030/025; G01N 27/62; G01N 30/6095

(57) ABSTRACT

A microfluidic photoionization detector (PID) may include a substrate and an electrically conductive layer formed on the substrate. The electrically conductive layer may include a microchannel, and a first electrode region and a second electrode region separated from each other by the microchannel, an ohmic contact layer formed on top of the first electrode region and the second electrode region, and a light source formed on the ohmic contact layer for emitting light toward the microchannel.

### TECHNICAL FIELD

The present disclosure relates generally to a microchannel photoionization detector. More specifically, the present disclosure relates to a microchannel photoionization detector that may be deployed in a gas chromatography system.

### BACKGROUND

The statements in this section merely provide background information related to the present disclosure and may not constitute prior art.

A photoionization detector (PID) is conventionally used to detect the presence of certain chemical compounds in a fluid sample (e.g., gas). The PID ionizes molecules of the fluid sample by exposing the sample to high-energy photons, thereby producing ions. The ions flow under an electric field to generate an electrical current, which can be measured to indicate a relative concentration of a certain compound.

A typical PID includes an ionization cell in which the fluid sample is ionized. The ionization cell is usually a vacuum chamber, which consumes a large volume. Such an ionization cell renders the PID unsuitable for use in a miniaturized, portable gas analytical system, such as a micro gas chromatography (GC) system.

### SUMMARY

According to one aspect of the present disclosure, a microfluidic photoionization detector (PID) is provided. The PID includes a substrate, an electrically conductive layer formed on the substrate, the electrically conductive layer including a microchannel. The electrically conductive layer further includes a first electrode region and a second electrode region separated from each other by the microchannel. The PID further includes an ohmic contact layer formed on top of the first electrode region and the second electrode region, and a light source formed on the ohmic contact layer for emitting light toward the microchannel.

According to one aspect of the present disclosure, a microfluidic photoionization detector (PID) is provided. The PID includes a substrate, an electrically conductive layer formed on the substrate, the electrically conductive layer including a microchannel. The electrically conductive layer further includes a first electrode region and a second electrode region separated from each other by the microchannel. The PID further includes a light source formed on the ohmic contact layer for emitting light toward the microchannel, and a light transmitting layer disposed between the electrically conductive layer and the light source and bonded to the electrically conductive layer.

It is to be understood that both the foregoing general description and the following detailed description are exemplary and explanatory only and are not restrictive of the claims.

### BRIEF DESCRIPTION OF THE DRAWINGS

The accompanying drawings, which are incorporated in and constitute a part of this specification, illustrate example embodiments and, together with the description, serve to explain the principles of the embodiments. In the drawings:

FIG. 1A is a schematic illustration of a gas chromatograph (GC) system in a sampling operation, according to one embodiment of the present disclosure.

FIG. 1B a schematic illustration of a GC system in analyzing operation, according to one embodiment of the present disclosure.

FIG. 2 is a schematic illustration of a photoionization detector (PID) in an exploded perspective view, according to one embodiment of the present disclosure.

FIG. 3A is a top view of a light transmitting layer and an ohmic contact layer, included in a PID, according to an embodiment of the present disclosure.

FIG. 3B is an exploded view of an ohmic contact layer, an electrically conductive layer, and columns included in a PID, according to an embodiment of the present disclosure.

FIG. 4 is an exploded view of an electrically conductive layer, an ohmic contact layer, and columns included in a PID, according to another embodiment of the present disclosure.

FIG. 5A is a schematic illustration of a PID in a perspective view, according to one embodiment of the present disclosure.

FIG. 5B is a schematic illustration of a PID in a cut-out perspective view, according to one embodiment of the present disclosure.

Corresponding reference numerals indicate corresponding parts throughout the several views of drawings.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations. Instead, they are merely examples of devices and methods consistent with aspects related to the appended claims.

Embodiments of the present disclosure address one or more disadvantages associated with the conventional photoionization detectors (PIDs). In one aspect, the present disclosure provides a PID that may include an electrically conductive layer formed of an electrically conductive material such as doped semiconductor. The electrically conductive layer may be formed with a microfluidic channel (hereinafter referred to as “microchannel”), in which a fluid sample can be ionized. As a result, the size of the PID can be greatly reduced, making the PID suitable for use in a micro gas chromatography (GC) system.

According to one embodiment, the electrically conductive layer may include a first electrode region and a second electrode region physically separated from each other by the microchannel. An ohmic contact layer may be deposited on each one of the first electrode region and the second electrode region to form a first electrode and a second electrode, respectively. As a result, stable ohmic metal-semiconductor contacts may be formed at the first and second electrode regions, respectively. The stable ohmic contacts may avoid potential unstable base line readout due to the nonlinear environmental effect (e.g., temperature, humidity) of a non-ohmic barrier, charge pumping effect, and ground looping.

According to one embodiment, before depositing the ohmic contact layer, the electrically conductive layer may be formed with a plurality of concave portions. As a result, a strong bonding may be formed between the first electrode and the first electrode region, and between the second electrode and the second electrode region.

According to one embodiment, a light transmitting layer may be bonded to the electrically conductive layer deposited with the ohmic contact layer, to seal the microchannel formed in the electrically conductive layer. As a result, there may be no need to use an optical adhesive, such as epoxy, to seal the microchannel. Therefore, the contamination of the fluid sample by the adhesive may be eliminated and better performance consistency between different PIDs may be achieved.

According to one embodiment, a PID may further include an enclosure that encloses various components of the PID. The enclosure may shield the components of the PID from various environmental disturbances, such as AC powerline frequency noise and any electromagnetic field from the ambient environment. As a result, a base line noise level may be reduced.

According to one embodiment, a sealant may be employed to seal the various components of the PID within the enclosure. As a result, effect of the moisture and any other contaminants from the ambient environment may be eliminated.

According to one embodiment, the PID may be disposed in an oven, which is maintained in a controlled temperature. As a result, the controlled temperature setting may further reduce the effects of the environmental temperature fluctuation on the performance of the PID.

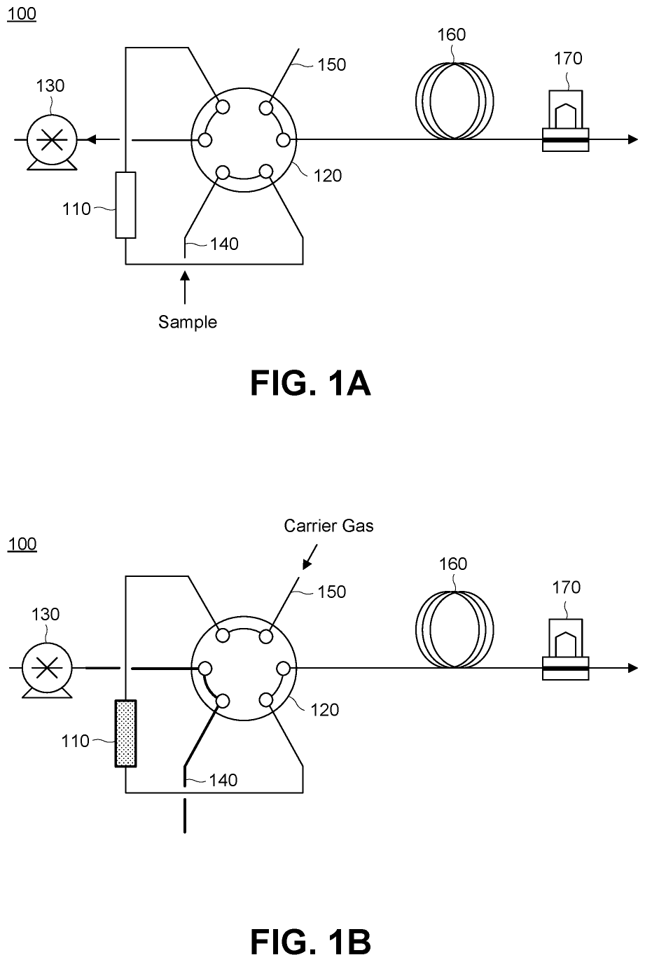

FIGS. 1A and 1B are schematic illustrations of a gas chromatograph (GC) system 100, according to one embodiment of the present disclosure. FIG. 1A illustrates the GC system 100 when it is performing a sampling operation, according to one embodiment of the present disclosure. FIG. 1B illustrates the GC system 100 when it is performing an analyzing operation, according to one embodiment of the present disclosure.

As shown in FIGS. 1A and 1B, the GC system 100 according to the embodiment of the present disclosure may include a preconcentrator 110, a six-point valve 120, a pump 130, a sample inlet 140, a carrier gas inlet 150, a column module 160, and a PID 170. The sample inlet 140 may be used for introducing a fluid sample into the GC system 100. The fluid sample may include gases, vapors, liquids, and the like. For example, the fluid sample may be volatile organic compounds (VOCs). The carrier inlet 150 may be used for introducing a carrier gas into the GC system 100. For example, the carrier gas may be an inert gas.

In the embodiment shown in FIG. 1A, during the sampling operation, the six-point valve 120 may be configured to connect the preconcentrator 110 with the pump 130 and the sample inlet 140, and disconnect the preconcentrator 110 from the carrier gas inlet 150 and the column module 160. When the pump 130 starts pumping, a fluid sample may enter the preconcentrator 110 through the sample inlet 140. The preconcentrator 110 may collect and concentrate the fluid sample.

In the embodiment shown in FIG. 1B, during the analyzing operation, the six-point valve 120 may be configured to connect the preconcentrator 110 with the carrier gas inlet 150 and the column module 160, and disconnect the preconcentrator 110 from the pump 130 and the sample inlet 140. A carrier gas may be introduced into the preconcentrator 110 through the carrier gas inlet 150. The carrier gas may carry the fluid sample collected in the preconcentrator 110 into the column module 160. The column module 160 may separate the fluid sample into various fluid components (analytes) having different retention times. The fluid components may then successively emerge from the column module 160 and enter the PID 170 according to their respective retention times.

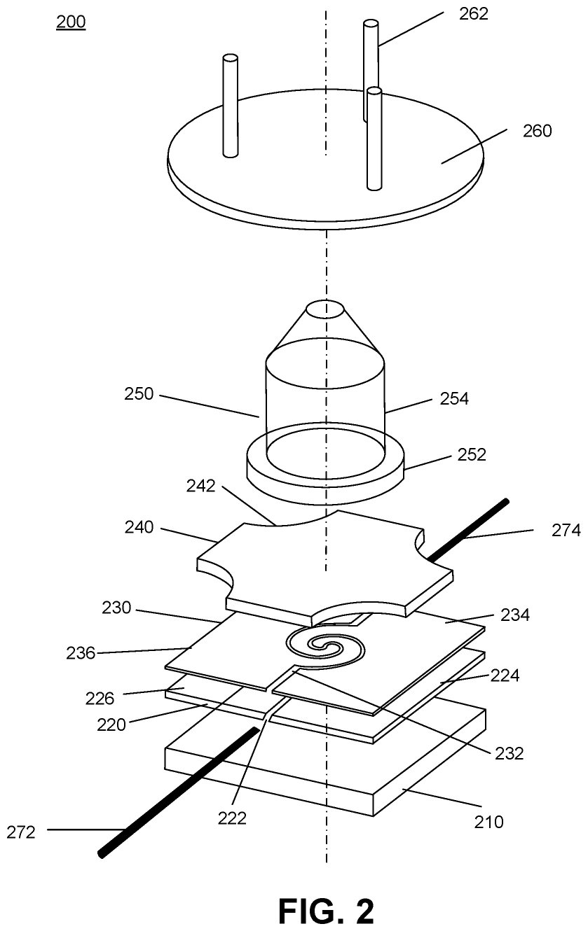

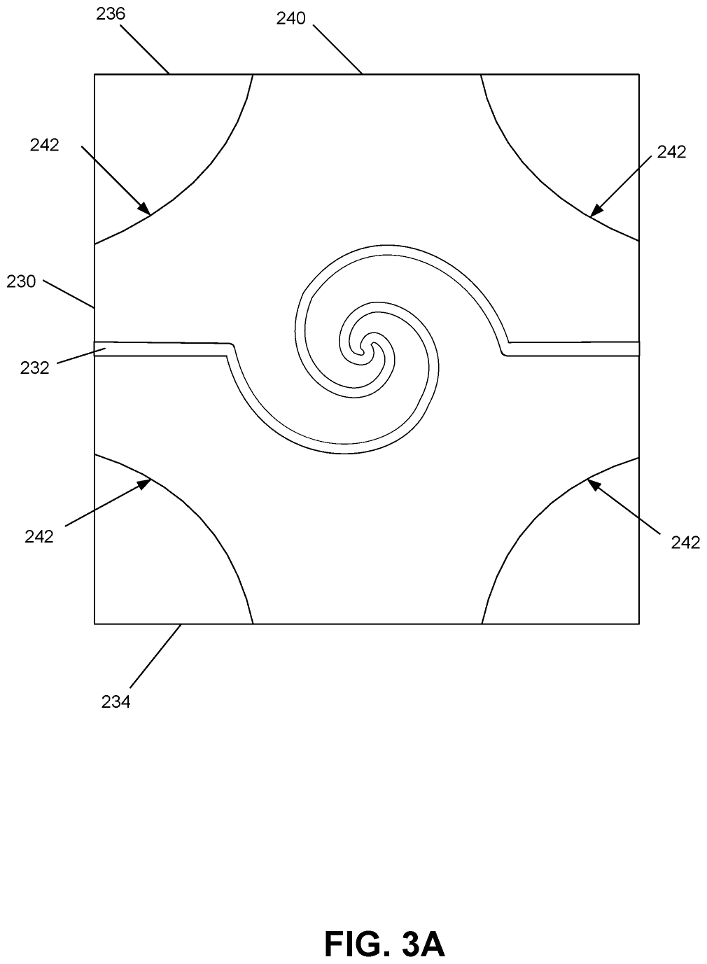

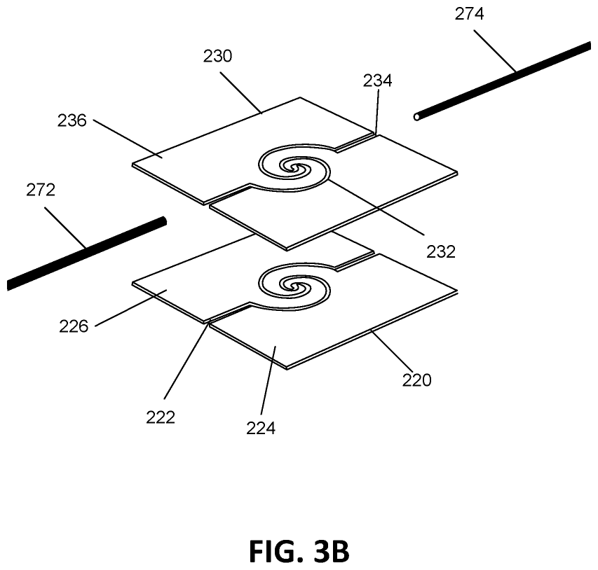

FIG. 2 is a schematic illustration of a microfluidic photoionization detector (PID) 200 in an exploded perspective view, according to one embodiment of the present disclosure. FIG. 3A is a top view of a light transmitting layer and an ohmic contact layer, included in the PID 200, according to the embodiment of the present disclosure. FIG. 3B is an exploded view of the ohmic contact layer, the electrically conductive layer, and columns included in the PID 200, according to the embodiment of the present disclosure. The PID 200 may be implemented as the PID 170 in the GC system 100 illustrated in FIGS. 1A and 1B.

As shown in FIGS. 2, 3A, and 3B, the PID 200 according to the exemplary embodiment of the present disclosure may include, sequentially from a bottom toward a top of the PID 200, a substrate 210, an electrically conductive layer 220, an ohmic contact layer 230, a light transmitting layer 240, a light source 250, and a printed circuit board (PCB) 260. The electrically conductive layer 220 may include a microfluidic channel (hereinafter referred to as “microchannel”) 222, a first electrode region 224, and a second electrode region 226. As shown, the first electrode region 224 and the second electrode region 226 are separated from each other by the microchannel 222. Opposite ends of the microchannel 222 may be connected to an upstream column 272 and a downstream column 274, respectively. The ohmic contact layer 230 may include a first contact 234 disposed on the first electrode region 224 and a second contact 236 disposed on the second electrode region 226.

As shown in FIG. 3B, the ohmic contact layer 230 may be formed on the electrically conductive layer 220. The upstream column 272 may be fitted into one end of the microchannel 222, and the downstream column 274 may be fitted into the opposite end of the microchannel 222.

During operation of the PID 200, fluid components of a fluid sample may successively enter the microchannel 222 via the upstream column 272, and successively exit the microchannel 222 via the downstream column 274. The light source 250 may emit light, typically in the ultraviolet (UV) range, toward the microchannel 222. High-energy photons included in the emitted light may break the molecules in a fluid component in the microchannel 222, producing positively charged ions and free electrons. Meanwhile, the first contact 234 and the second contact 236 may be applied with different voltages to form an electric field. The electric field may cause the ions to flow between the first electrode region 224 and the second electrode region 226, thus producing an electric current. The electric current may be measured to indicate a relative concentration of the fluid component.

The substrate 210 may be formed of any suitable material that can sustain the various components of the PID 200. For example, the substrate 210 may be formed of glass.

The electrically conductive layer 220 may be formed on top of the substrate 210 by, for example, anodically bonding. The electrically conductive layer 220 may be formed of any type of electrically conductive material. For example, the electrically conductive layer 220 may be formed of a conductive doped semiconductor material (e.g., silicon). In some embodiments, the electrically conductive layer 220 may include the microchannel 222, the first electrode region 224, and the second electrode region 226. The microchannel 222 may be formed by etching through the electrically conductive layer 220 using, for example, photolithography and deep reactive-ion etching (DRIE). As a result, the first electrode region 224 and the second electrode region 226 may be insulated and physically separated from each other by the microchannel 222.

The electrically conductive layer 220 may have a thickness ranging from about 20 nm to about 2 μm. Alternatively, the electrically conductive layer 220 may be thicker or thinner than the range disclosed above, as long as it serves its required purpose. In some embodiments, the electrically conductive layer 220 may be thicker than an external diameter of the columns 272 and 274, so that there is enough space for fitting the columns 272 and 274 into the microchannel 222 included in the electrically conductive layer 220. The typical external diameter of the columns 272 and 274 may range from 100 μm to 1000 μm, and the thickness of the electrically conductive layer 220 may be larger than the external diameter of the columns 272 and 274. For example, when the external diameter of the columns 272 and 274 is 380 μm, the thickness of the electrically conductive layer 220 may be 500 μm.

The ohmic contact layer 230 may be formed on top of the electrically conductive layer 220 to form a stable ohmic contact between the ohmic contact layer 230 and the electrically conductive layer 220. In some embodiments, the ohmic contact layer 230 may include the first contact 234 formed on top of the first electrode region 224 and the second contact 236 formed on top of the second electrode region 226. In one embodiment, the ohmic contact layer 230 may be deposited on the entire top surface of the electrically conductive layer 220, and then etched to remove the portion deposited in the microchannel 222 to form the first contact 234, the second contact 236, and a gap 232 between the first contact 234 and the second contact 236. Thus, the first contact 234 may be physically separated and electrically insulated from the second contact 236 by the gap 232.

The ohmic contact layer 230 may be formed in any structure and may be formed of any electrically conductive material that can function as electrical contacts for the electrically conductive layer 220. In some embodiments, the ohmic contact layer 230 may be formed as a layer including a metal or any other electrically conductive material. The metal or the other electrically conductive material may be uniformly or non-uniformly included in the ohmic contact layer 230. The metal may be selected from a group of metal such as, for example, platinum (Pt), gold (Au), silver (Ag), and copper (Cu). The other electrically conductive material may be, for example, graphene. In some alternative embodiments, the ohmic contact layer 230 may be a multilayer including at least a first layer and a second layer formed on top of the first layer. The first layer may be formed on top of the electrically conductive layer 220 to function as an adhesion layer. The first layer may have properties of good conductivity and good adhesion to the underlying electrically conductive layer 220, which may be formed of silicon, to facilitate the adhesion of the second layer to the electrically conductive layer 220. The first layer may be formed of a first metal selected from a group of metal such as: chromium (Cr), titanium (Ti), and aluminum (Al). The first layer may have a thickness of 0.5 nm to 10 nm. The second layer may function as a contact layer. The second layer may have properties of good conductivity and environmental stability (such as, for example, antioxidation). The second layer may be formed of a second metal selected from a group of platinum (Pt), gold (Au), silver (Ag), and copper (Cu). The second layer may have a thickness of 20 nm to 2 um. When fabricating the PID 200, the first layer may be first deposited on the electrically conductive layer 220, and then the second layer may be deposited on top of the first layer. Still alternatively, the ohmic contact layer 230 may be formed of any other material or combination of materials that can function as electrical contacts to the electrically conductive layer 220.

In a comparable PID, there is no ohmic contact layer formed on the first electrode region 224 and the second electrode region 226. Instead, a first electrical connector (e.g., a copper wire) is connected to a limited portion of the first electrode region 224, and a second electrical connector is connected to a limited portion of the second electrode region 226. As a result, non-ohmic barriers may be formed at the interface between the first electrical connector and the first electrode region 224 and between the second electrical connector and the second electrode region 226. Because the non-ohmic barriers may have nonlinear environmental effect (e.g., temperature, humidity), issues such as unstable base line readout, charge pumping effect, and ground looping may arise. According to the embodiments of the present disclosure, the ohmic contact layer 230 may be deposited on the entire top surfaces of the first electrode region 224 and the second electrode region 226. In this manner, a stable ohmic contact may be formed in the first electrode region 224 and the second electrode region 226. The stable ohmic contact may avoid potential unstable base line readout due to the nonlinear environmental effect (e.g., temperature, humidity) of the non-ohmic barrier, charge pumping effect, and ground looping.

In some embodiments, the light source 250 may include a plate 252 and a source body 254. The plate 252 may be disposed below the source body 254 and attached to the source body 254. The source body 254 may be electrically connected to an external power source (not illustrated) and, in response to an electric power supplied by the external power source, the source body 254 may emit light through the plate 252 toward the microchannel 222 in the electrically conductive layer 220. The wavelength of the light emitted by the source body 254 may be in the ultraviolet (UV) range. The plate 252 may be formed of a light transmitting material that may transmit, at least partially, the light emitted by the source body 254. In some embodiments, the plate 252 may be formed of materials such as lithium fluoride (LiF), magnesium fluoride (MgF₂), calcium fluoride (CaF₂), barium fluoride (BaF₂), aluminum oxide (Al₂O₃), or silicon dioxide (SiO₂) depending on the wavelength of the light source.

In some embodiments, the light transmitting layer 240 may be disposed between the light source 250, which may include the plate 252 and the source body 254, and the ohmic contact layer 230. The light transmitting layer 240 may be physically or chemically bonded to the electrically conductive layer 220 formed with the ohmic contact layer 230. The bonding between the light transmitting layer 240 and the electrically conductive layer 220 may be achieved by processes such as anodize bonding (electrostatic bonding), direct bonding, thermal-compression bonding, and adhesive bonding. In some embodiments, the light transmitting layer 240 may be formed of a material that can transmit, at least partially, the light emitted by the light source 250. The light transmitting layer 240 may be configured to have a transmission efficiency that is equal to or above a predetermined threshold value, such that the amount of photons included in the light transmitted through the light transmitting layer 240 is sufficiently large to ionize the molecules of the fluid components in the microchannel 222 of the electrically conductive layer 220. In some embodiments, the light transmitting layer 240 may be formed of materials such lithium fluoride (LiF), magnesium fluoride (MgF₂), calcium fluoride (CaF₂), barium fluoride (BaF₂), aluminum oxide (Al₂O₃), or silicon dioxide (SiO₂) depending on the wavelength of the light source.

In some embodiments, to further enhance the transmission of light, the light transmitting layer 240 may be coated with a coating layer. In addition, the coating layer on the light transmitting layer 240 may have a certain pattern. For example, the pattern of the coating layer may include gratings or grids. However, the present disclosure does not limit the material and the pattern of the coating layer.

In some embodiments, the light transmitting layer 240 is bonded to the electrically conductive layer 220 and the ohmic contact layer 230 to seal the microchannel 222. As a result, the microchannel 222 may be enclosed by a top wall formed of the light transmitting layer 240, a bottom wall formed of the substrate 210, and two side walls formed by the electrically conductive layer 220.

In a comparative PID, the light source 250 is directly attached to the electrically conductive layer 220 by gluing the plate 252 of the light source 250 onto the electrically conductive layer 220 using an optical adhesive formed of epoxy or a similar compound. The adhesive may contaminate the fluid component (e.g., VOC) in the microchannel 222. In the embodiment of the present disclosure, the light transmitting layer 240 may be bonded to the electrically conductive layer 220 and the ohmic contact layer 230 to seal the microchannel 222. In this manner, the usage of an adhesive such as epoxy or any other compound can be avoided, thereby eliminating the contamination of the fluid sample by the adhesive and providing better performance consistency between different PIDs. In addition, there is no need to attach the light source 250 to the electrically conductive layer 220, making it easier to maintain and exchange the light source 250.

In some embodiments, the PCB 260 may be disposed above the light source 250. The PCB 260 may include a driving circuit, a signal amplification circuit, and electrical connectors 262 to be connected to an external circuit. In this regard, the light transmitting layer 240 may include windows 242 at the corners of the light transmitting layer 240. FIG. 3A is a top view of the light transmitting layer 240 and the ohmic contact layer 230 included in the PID 200, according to the embodiment of the present disclosure. As shown in FIG. 3A, the light transmitting layer 240 may be formed on the ohmic contact layer 230. The windows 242 may expose the ohmic contact layer 230 disposed below the light transmitting layer 240, allowing connection of the ohmic contact layer 230 to the driving circuit and signal amplification circuit in the PCB 260.

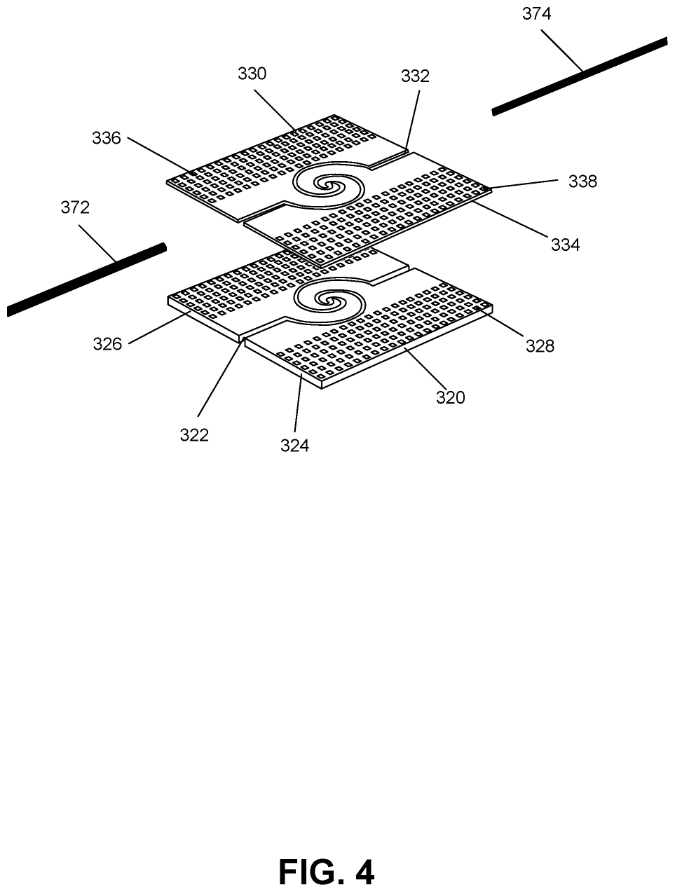

FIG. 4 is an exploded view of an electrically conductive layer 320, an ohmic contact layer 330, and columns 372 and 374 included in a PID, according to another embodiment of the present disclosure.

As shown in FIG. 4, the electrically conductive layer 320 may include a first electrode region 324, a second electrode region 326, and a microchannel 322 formed between the first electrode region 324 and the second electrode region 326. The ohmic contact layer 330 may include a first contact 334, a second contact 336, and a gap formed between the first contact 334 and the second contact 336. The ohmic contact layer 330 may be formed by depositing an electrically conductive material on the electrically conductive layer 320.

In addition, to improve the physical bonding between the ohmic contact layer 330 and the electrically conductive layer 320, prior to depositing the ohmic contact layer 330 on the electrically conductive layer 320, the top surface of the electrically conductive layer 320 may be etched to form a plurality of concave patterns 328. The depth of the concave patterns 328 may be approximately 10 nm to approximately 200 nm. Then, when the ohmic contact layer 330 is formed on the electrically conductive layer 320, the ohmic contact layer 330 may have a shape in conformance with the top surface of the electrically conductive layer 320. As a result, the ohmic contact layer 330 may become a patterned layer formed with a plurality of concave patterns 338 as well. The plurality of concave patterns 328 and 338 may improve the bonding strength between the ohmic contact layer 330 and the electrically conductive layer 320 and reduce thermal diffusion of metals from the ohmic contact layer 330 toward the electrically conductive layer 320, thereby enabling stronger bonding between the ohmic contact layer 330 and the electrically conductive layer 320, and allowing the PID to work under higher temperatures.

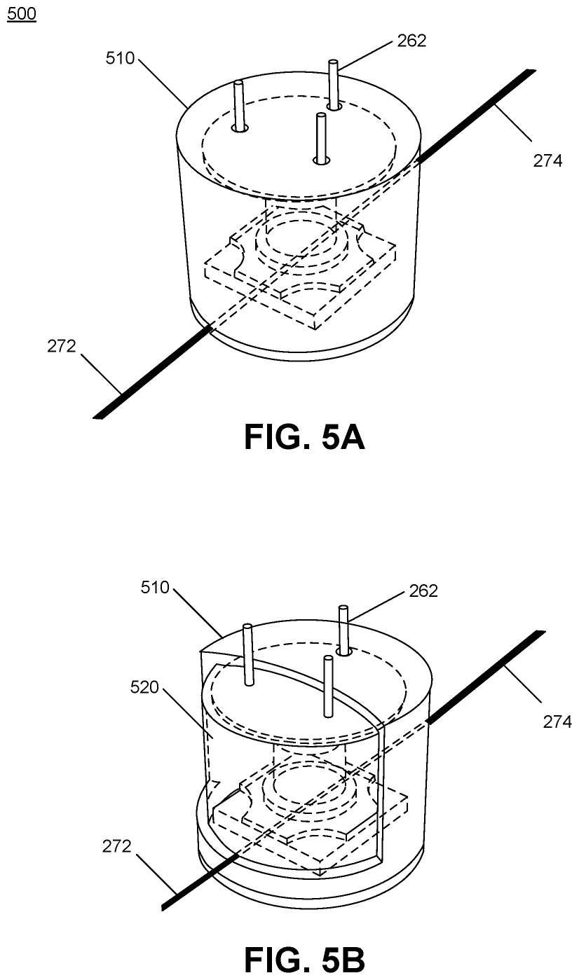

FIGS. 5A and 5B are schematic illustrations of a PID 500, according to one embodiment of the present disclosure. FIG. 5A illustrates a perspective view of the PID 500. FIG. 5B illustrates a cut-out perspective view of the PID 500.

The PID 500 in the embodiment illustrated in FIGS. 5A and 5B may include various components of the PID illustrated in FIGS. 2, 3A, 3B, and 4. The various components may include the substrate 210, the electrically conductive layer 220 or 320, the ohmic contact layer 230 or 330, the light transmitting layer 240, the light source 250, and the PCB 260. The properties and the arrangement of these components are the same as those in the embodiment illustrated in FIGS. 2, 3A, 3B, and 4. Therefore, detailed descriptions of these components are not repeated here.

In the embodiment illustrated in FIGS. 5A and 5B, the PID 500 may further include an enclosure 510 that enclosures the above-mentioned components of the PID 500, including the substrate 210, the electrically conductive layer 220 or 320, the ohmic contact layer 230 or 330, the light transmitting layer 240, the light source 250, and the PCB 260. The enclosure 510 may be formed of any appropriate material. The enclosure 510 may be made by either single element or an alloy of steel, copper, nickel, aluminum, magnesium, platinum, gold, carbon, or any other element or alloy, or even plastic coated/taped with conductive layer, as long as they serve the purpose of providing a rigid enclosure and being conductive to provide electromagnetic screening effect. For example, enclosure 510 may provide a rigid enclosure and be electrically conductive to provide an electromagnetic screening effect. In some embodiments, the enclosure 510 may be a single element selected from a group of steel, copper, nickel, aluminum, magnesium, platinum, gold, or carbon, or an alloy of two or more elements selected from the group. Alternatively, the enclosure 510 may be formed of plastic coated or taped with a conductive layer. The enclosure 510 may be formed with openings to allow the electrical connectors 262 of the PCB 260 to protrude outside of the enclosure 510, in order to be connected to an external circuit. In addition, the enclosure 510 may be formed with openings to allow the upstream column 272 and the downstream column 274 to be connected with the microchannel 222 formed in the electrically conductive layer 220.

The enclosure 510 may be configured to electromagnetically shield various components of the PID 500, including the PCB 260 formed with the driving circuit and the signal amplification circuit, from AC powerline frequency noise and an electromagnetic field from the ambient environment. Compared to a PID without the enclosure, the enclosure 510 may suppress a base line noise level from about 2 mV down to about 0.1 mV, which is a twenty times improvement.

The enclosure 510 may be shorted to the ground of the PID 500. Alternatively, when the PID 500 is included in a GC system which is enclosed in a chassis, the enclosure 510 may be shorted to the chassis.

The chassis of the GC system may provide further electromagnetic shielding for the PID 500. The chassis may yield 0.05 mV of the base line noise level, which is an additional two times of improvement, compared to a PID without the chassis.

As shown in FIG. 5B, a sealant 520 may be further disposed within the enclosure 510 to seal the components of the PID 500. That is, after the substrate 210, the electrically conductive layer 220 or 320, the ohmic contact layer 230 or 330, the light transmitting layer 240, the light source 250, and the PCB 260 are assembled and disposed within the enclosure 510, the remaining space within the enclosure 510 may be filled with the sealant 520. The sealant 520 may be a silicone-based sealant or an epoxy-based sealant. The sealant 520 may seal the components of the PID 500 from the ambient environment, thereby eliminating the effect of the moisture and any other contaminants.

In some embodiments, in order to avoid the effect of environmental temperature fluctuation, the PID 200 or 500 can be placed in an oven which is maintained in a controlled temperature of around 40° C. to 350° C. The temperature may be controlled according to different measurement schemes. For example, higher temperature may be used when less residue is desired. The materials used for forming the PID 200 or 500 may be selected according to the controlled temperature. For example, the materials used for forming the PID 200 or 500 may be able to withstand the controlled oven temperature. Taking the material for the enclosure 510, as an example, a metal enclosure may be versatile and may withstand temperature above 200° C. For a designed oven temperature below 100° C., a majority of other materials, such as plastic (e.g., PTFE, PEEK, Nylon, PC, ABS and so on), may be used for the enclosure 510. In such case, although the PID may still be functional, it may be susceptible to EMI (electromagnetic interference) without the metal enclosure.

In addition, in some embodiments, the electrically conductive layer 220 and the light source 250 may be encapsulated separately from the PCB 260. That is, the electrically conductive layer 220 and light source 250 may be encapsulated in a first enclosure, and the PCB 260 may be encapsulated in a second and separate enclosure. In this manner, even if the PID 200 or 500 is heated to 100° C. to 300° C., the PID 200 or 500 may still remain stable.

While illustrative embodiments have been described herein, the scope of the present disclosure covers any and all embodiments having equivalent elements, modifications, omissions, combinations (e.g., of aspects across various embodiments), adaptations and/or alterations as would be appreciated by those skilled in the art based on the present disclosure. For example, features included in different embodiments shown in different figures may be combined. The limitations in the claims are to be interpreted broadly based on the language employed in the claims and not limited to examples described in the present specification or during the prosecution of the application. The examples are to be construed as non-exclusive. It is intended, therefore, that the specification and examples be considered as illustrative only, with a true scope and spirit being indicated by the following claims and their full scope of equivalents.

What is claimed is:

1. A microfluidic photoionization detector (PID), comprising:
a substrate;
an electrically conductive layer formed on the substrate, the electrically conductive layer including a microchannel, wherein the electrically conductive layer further includes a first electrode region and a second electrode region separated from each other by the microchannel;
an ohmic contact layer formed on top of the first electrode region and the second electrode region; and
a light source formed on the ohmic contact layer for emitting light toward the microchannel.

2. The microfluidic PID of claim 1, wherein the electrically conductive layer is formed of a doped semiconductor material.

3. The microfluidic PID of claim 1, wherein the first electrode region and the second electrode region are formed with a plurality of concave patterns.

4. The microfluidic PID of claim 1, wherein the ohmic contact layer is formed with a plurality of concave patterns.

5. The microfluidic PID of claim 1, wherein the ohmic contact layer may be a layer in which an electrically conductive material is uniformly included.

6. The microfluidic PID of claim 1, wherein the ohmic contact layer may be a multilayer comprising:
a first layer formed on top of the first electrode region and the second electrode region; and
a second layer formed on top of the first layer.

7. The microfluidic PID of claim 1, further comprising:
a light transmitting layer disposed between the ohmic contact layer and the light source.

8. The microfluidic PID of claim 7, wherein the light transmitting layer is bonded to the electrically conductive layer.

9. The microfluidic PID of claim 7, further comprising:
a coating layer formed on the light transmitting layer.

10. The microfluidic PID of claim 1, further comprising:
a printed circuit board disposed on top of the light source.

11. The microfluidic PID of claim 10, further comprising:
an enclosure enclosing the substrate, the electrically conductive layer, the ohmic contact layer, the light source, and the printed circuit board.

12. The microfluidic PID of claim 11, further comprising:
a sealant filled within the enclosure.

13. A gas chromatography system comprising the microfluidic PID of claim 1.

14. A microfluidic photoionization chip, comprising:
a substrate;
an electrically conductive layer formed on the substrate, the electrically conductive layer including a microchannel, wherein the electrically conductive layer further includes a first electrode region and a second electrode region separated from each other by the microchannel;
an ohmic contact layer formed on top of the first electrode region and the second electrode region; and
a light transmitting layer disposed on the ohmic contact layer.

15. A microfluidic photoionization detector (PID), comprising:
the microfluidic photoionization chip of claim 14; and
a light source formed on the light transmitting layer for emitting light toward the microchannel.

16. A gas chromatography system comprising the microfluidic PID of claim 15.
